(19) United States
(12) Patent Application Publication
(10) Pub. No.: US 2022/0323951 A1
(43) Pub. Date: Oct. 13, 2022

(54) EXTRACTION DEVICE AND TEST SYSTEM

(71) Applicant: KONICA MINOLTA, INC., Tokyo (JP)

(72) Inventors: Kengo FUSHIYA, Toyokawa-shi (JP); Masahiro MATSUO, Tokyo (JP); Hiroshi MORIMOTO, Tokyo (JP); Takahiro HARA, Tokyo (JP)

(73) Assignee: KONICA MINOLTA, INC., Tokyo (JP)

(21) Appl. No.: 17/690,082

(22) Filed: Mar. 9, 2022

(30) Foreign Application Priority Data
Apr. 9, 2021 (JP) 2021-066294

(51) Int. Cl. B01L 3/00

(52) U.S. Cl. CPC B01L 3/508; B01L 2300/042; B01L 2300/046; B01L 2300/0663; B01L 2200/026; B01L 2400/049

(57) ABSTRACT

An extraction device includes an extraction container including a discharge port and capable of storing a biological sample and an extractant, a discharge accelerator configured to discharge the biological sample extracted into the extractant in the extraction container from the discharge port, and a controller configured to instruct the discharge accelerator to discharge the biological sample from the discharge port.

### CROSS-REFERENCE TO RELATED APPLICATION

Japanese patent application No. 2021-066294 filed on Apr. 9, 2021, including description, claims, drawings, and abstract the entire disclosure is incorporated herein by reference in its entirety.

### BACKGROUND

### 1. Technological Field

The present invention relates to an extraction device and a test system.

### 2. Description of the Related Arts

A test for detecting a virus or the like from a biological sample is performed, for example, as follows. First, a tester such as a doctor and a nurse collects a biological sample such as saliva or a nasal swab from the pharynx, nasal cavity, or the like of a subject using a cotton swab or the like. Subsequently, the cotton swab or the like to which the biological sample adheres is immersed in an extractant to extract the biological sample. Thereafter, the biological sample extracted into the extractant is dripped onto a predetermined place to react with a reagent, whereby the test is performed (Refer to Unexamined Japanese Patent Publication No. 2007-71698).

### SUMMARY

As explained above, such a test is often performed by a doctor, a nurse, or the like who is accustomed to handling of a biological sample However, a certain degree of experience and skill is required for a test process such as extraction of a biological sample. It is difficult to perform the test with high accuracy and safety when the test is performed by a tester who is unaccustomed to handling of a biological sample.

The present invention has been made in view of the above circumstances, and an object of the present invention is to provide an extraction device and a test system capable of simplifying a test process. The above object of the present invention is achieved by the following.

To achieve at least one of the abovementioned objects, according to an aspect of the present invention, an extraction device reflecting one aspect of the present invention comprises an extraction container including a discharge port and capable of storing a biological sample adhering to a collection tool and an extractant into which said biological sample is extracted; a discharge accelerator configured to discharge said biological sample extracted into said extractant in said extraction container from said discharge port; and a controller configured to instruct said discharge accelerator to discharge said biological sample from said discharge port.

Moreover, to achieve the above-mentioned object, according to an aspect of the present invention, a test system reflecting one aspect of the present invention by comprising above extraction device.

Other objects, features and characteristics of the present invention are clarified by referring to preferred embodiments illustrated in the following explanation and the accompanying drawings. (The objects, features, and characteristics of this invention other than those set forth above will become apparent from the description given herein below with reference to preferred embodiments illustrated in the accompanying drawings.)

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram illustrating an example of a configuration of an extraction device according to an embodiment;

FIG. 2 is a plan view illustrating an example of a configuration of a side surface of the extraction container illustrated in FIG. 1;

FIG. 3 is a plan view illustrating an example of a configuration of an upper surface of a columnar portion and an insertion portion illustrated in FIG. 2;

FIG. 4 is a plan view illustrating a schematic configuration of a side surface of a test system in which the extraction device illustrated in FIG. 1 and the like is used;

FIG. 5 is a plan view illustrating a configuration of an upper surface of the test system illustrated in FIG. 4;

FIG. 6A is a plan view illustrating a configuration of a side surface of a detector illustrated in FIG. 4 and the like, and FIG. 6B is a plan view illustrating a configuration of an upper surface of the detector illustrated in FIG. 6A; and

FIG. 7 is a flowchart illustrating an example of a test method in which the test system illustrated in FIG. 4 and the like is used.

### DETAILED DESCRIPTION OF EMBODIMENTS

Hereinafter, one or more embodiments of the present invention will be described with reference to the drawings. However, the scope of the invention is not limited to the disclosed embodiments.

An embodiment of an extraction device and a test system of the present invention is explained below with reference to the accompanying drawings. In the drawings, the same members are denoted by the same reference numerals and signs. Dimensional ratios of the drawings are sometimes exaggerated for convenience of explanation and are different from actual ratios.

### Embodiment

<Configuration of an Extraction Device>

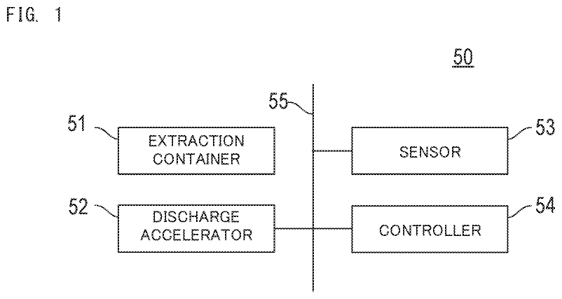

FIG. 1 illustrates an example of a configuration of an extraction device 50 according to an embodiment of the present invention. The extraction device 50 includes, for example, an extraction container 51, a discharge accelerator 52, a sensor 53, and a controller 54. The discharge accelerator 52, the sensor 53, and the controller 54 are connected to one another via, for example, a bus 55. The extraction container 51 may be further connected via the bus 55.

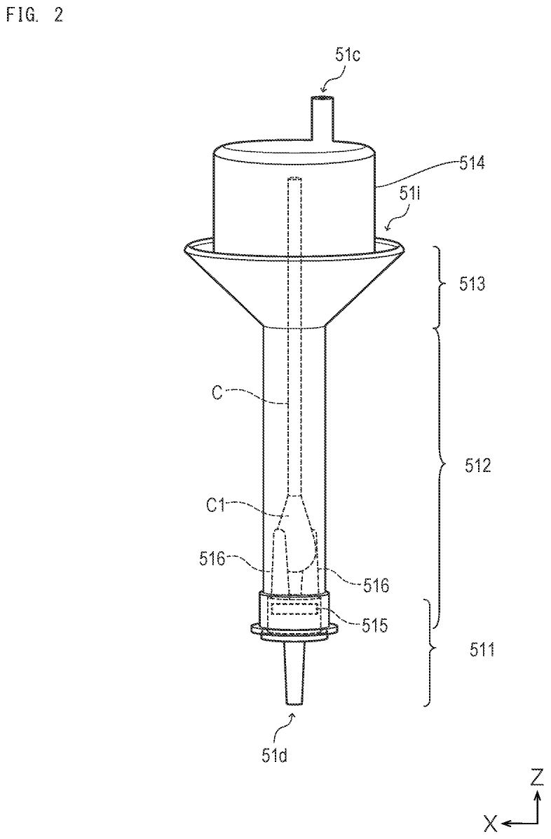

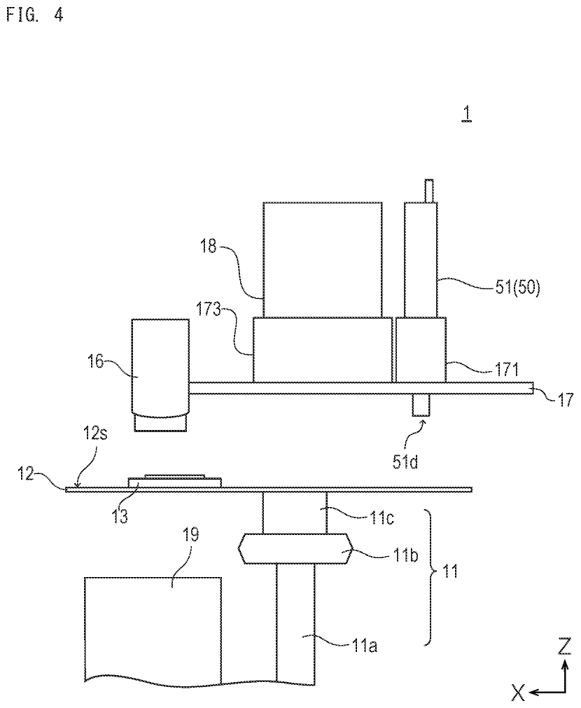

The extraction device 50 is used, for example, in a test system (for example, a test system 1 illustrated in FIG. 4 explained below) for detecting a virus or the like from a biological sample. The extraction device 50 plays a role of extracting a biological sample of a subject adhering to a collection tool (for example, a collection tool C illustrated in FIG. 2 explained below) such as a cotton swab with an extractant and supplying the extracted biological sample to a predetermined place. In the test system, for example, the biological sample and a reagent are mixed in the place to which the biological sample is supplied.

FIG. 2 is a diagram illustrating an example of a configuration of a side surface (XZ plane) of the extraction container 51. The extraction container 51 includes a nozzle portion 511, a columnar portion 512, an insertion portion 513, and a lid 514 in this order, for example, along a predetermined direction (a Z direction in FIG. 2). A discharge port 51d is provided in the nozzle portion 511. The biological sample and the extractant stored in the extraction container 51 are discharged via the discharge port 51d. An insertion port 51i is provided in the insertion portion 513. The collection tool C or the like to which the biological sample adheres is inserted into the extraction container 51 from the insertion port 51i. The lid 514 is provided to cover the insertion port 51i. The extraction container 51 is, for example, preferably disposable and is, for example, replaced every one to several times and used.

The nozzle portion 511 is disposed at an end of the extraction container 51. The discharge port 51d is provided at the distal end of the nozzle portion 511. The nozzle portion 511 is, for example, configured to be detachably attachable to one end of the columnar portion 512. A part of the nozzle portion 511 is inserted into the columnar portion 512. For example, a filter 515 is provided in the nozzle portion 511. The biological sample and the extractant having passed through the filter 515 are discharged from the discharge port 51d. In other words, the biological sample and the extractant flowing toward the discharge port 51d pass through the filter 515. Solid impurities, viscous impurities, and the like contained in the biological sample are removed by the filter 515. By providing such a filter 515 in the extraction container 51, it is possible to suppress occurrence of a deficiency such as clogging of the discharge port 51d. The filter 515 is configured by, for example, an organic material or an inorganic material. Examples of the organic material include polyethylene, polypropylene, fluorine-based resin, and nylon resin.

The colunmar portion 512 provided between the nozzle portion 511 and the insertion portion 513 is disposed to extend in the Z direction. A predetermined amount of the extractant and at least a sample adhering portion (hereinafter referred to as an adhering portion C1) of the collection tool C are stored in the columnar portion 512. The biological sample adhering to the collection tool C is extracted or dispersed to the extractant.

An extraction supporting structure 516 is provided in the colunmar portion 512. The extraction supporting structure 516 is provided, for example, near a coupling section to the nozzle portion 511. The extraction supporting structure 516 is configured by, for example, a protrusion extending in a predetermined direction. Specifically, the columnar portion 512 is constituted by two protrusions extending substantially parallel to the extending direction of the columnar portion 512 (the Z direction). For example, the two protrusions are disposed to face each other across the collection tool C inserted into the colunmar portion 512 and are configured such that, when the adhering portion C1 of the collection tool C is inserted between the two protrusions, the adhering portion C1 is rubbed against the protrusions. Accordingly, the biological sample adhering to the adhering portion C1 is rubbed off by the protrusions and is extracted or dispersed into the extractant. In FIG. 2, an example is illustrated in which the extraction supporting structure 516 is configured by the two protrusions. However, the extraction supporting structure 516 may be configured by three or more protrusions. The extending direction of the protrusions may be a direction crossing the extending direction of the colunmar portion 512. The protrusions may extend in, for example, an X direction or a Y direction. Alternatively, the extraction supporting structure 516 may be configured by a member having a curved shape such as a spiral shape.

The insertion portion 513 provided on the other end side of the columnar portion 512 has, for example, a funnel shape. The radius of the insertion portion 513 gradually increases as the insertion portion 513 is further away from the columnar portion 512. The insertion portion 513 is provided, for example, integrally with the columnar portion 512.

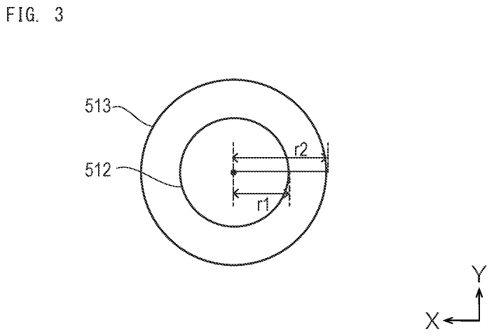

FIG. 3 illustrates a configuration of an upper surface (an XY plane) of the insertion portion 513 and the columnar portion 512. The columnar portion 512 has, for example, a first radius r1. The radius of the insertion portion 513 changes, for example, from the first radius r1 to a second radius r2 (r1<r2). In other words, an insertion port 51i provided in the insertion portion 513 has the second radius r2 larger than the first radius r1. Accordingly, it is easy to insert the collection tool C and the like into the extraction container 51. It is possible to suppress occurrence of an operation mistake or the like of the tester when the collection tool C is inserted into the extraction container 51. The insertion port 51i and the discharge port 51d are disposed, for example, along the extending direction of the columnar portion 512 (the Z direction).

The lid 514 covering the insertion port 51i is configured to be detachably attachable to the insertion portion 513 (FIG. 2). The lid 514 has, for example, a substantially columnar shape. The radius of the lid 514 is, for example, smaller than the second radius r2. The lid 514 is, for example, fitted in the insertion portion 513 via an O-ring. By covering the insertion port 51i with the lid 514 in this way, the extraction container 51 is sealed. A connection hole 51c connected to the discharge accelerator 52 is provided in the lid 514. The connection hole 51c of the extraction container 51 and the discharge accelerator 52 are connected via, for example, a joint and are configured to enable fluid such as air to flow into the extraction container 51 from the discharge accelerator 52.

The extraction container 51 including the nozzle portion 511, the columnar portion 512, the insertion portion 513, and the lid 514 explained above may be configured by a single material or may be configured by a plurality of materials. The extraction container 51 is configured by, for example, a resin material. By configuring the extraction container 51 using the resin material, cost can be suppressed and the extraction container 51 suitable for disposable use can be configured. Examples of the resin configuring the extraction container 51 include polyethylene, polypropylene, polystyrene, polyvinyl chloride, polycarbonate, polyester, polymethyl methacrylate, polyvinyl acetate, a vinyl-acetate copolymer, a styrene-methyl methacrylate copolymer, an acrylonitrile-styrene copolymer, an acrylonitrile-butadiene-styrene copolymer, nylon, polymethylpentene, silicon resin, amino resin, polysulfone, polyethersulfone, polyetherimide, fluororesin, polyimide, and the like.

The collection tool C inserted into the extraction container 51 is configured by, for example, a cotton swab or the like. The collection tool C is preferably disposable and is preferably easily incinerated. Since the collection tool C is easily incinerated, it is possible to suppress occurrence of infection via the collection tool C. A shaft portion of the cotton swab is configured by, for example, resin, paper, wood, metal, or the like. A cotton ball portion of the cotton swab is configured by absorbent cotton, fiber, resin, or the like. The shaft portion of the cotton swab is preferably configured by resin or paper. Accordingly, the cotton swab is easily used in a disposable manner and can be easily incinerated. The cotton ball portion may have an uneven structure. By providing the uneven structure in the cotton ball portion, the biological sample is easily held in the uneven structure. It is possible to cause the biological sample to more surely adhere to the collection tool C.

With such a collection tool C, for example, a biological sample is collected from a mucosal portion such as the nasal cavity or the oral cavity of a subject. The biological sample is, for example, body fluid collected from the mucosal portion and, specifically, is a nasal swab, saliva, or the like. The biological sample may be body fluid collected from a body fluid wet portion such as a wound. The biological sample may be collected directly or indirectly from the subject. The indirectly collected biological sample is, for example, a biological sample collected from a door knob or the like touched by the subject. The biological sample is preferably collected non-invasively from the subject. For example, DNA, RNA, protein, virus, bacteria, or the like contained in the biological sample reacts with a reagent, whereby a test is performed. An extractant is liquid capable of extracting the biological sample collected from the subject by the collection tool C, and is, for example, water or the like.

The discharge accelerator 52 plays a role of discharging, from the discharge port 51d, the biological sample extracted into the extractant in the extraction container 51. For example, the discharge accelerator 52 includes a pressurizer connected to the connection hole 51c of the extraction container 51 via a joint or the like and causes gas such as air to flow into the extraction container 51 in response to an instruction from the controller 54. Accordingly, the pressure inside the sealed extraction container 51 increases and the biological sample extracted into the extractant is discharged from the discharge port 51d. For example, a discharge amount can be adjusted by controlling an amount of the gas flowing into the extraction container 51. The discharge accelerator 52 may increase the pressure inside the extraction container 51 by causing the liquid to flow into the extraction container 51.

The discharge accelerator 52 may include, for example, a heater that heats the extraction container 51 and may increase the pressure inside the extraction container 51 by heating the extraction container 51. The extraction container 51 is heated, whereby the air in the extraction container 51 expands or the extractant vaporizes and the pressure inside the extraction container 51 increases. Accordingly, the biological sample extracted into the extractant is discharged from the discharge port 51d of the extraction container 51.

Alternatively, the discharge accelerator 52 may include a pressing member such as a roller that presses the extraction container 51 from the outside. The extraction container 51 is pressed from the outside, whereby the volume in the extraction container 51 decreases and the pressure inside the extraction container 51 increases. Accordingly, the biological sample extracted into the extractant is discharged from the discharge port 51d of the extraction container 51.

The discharge accelerator 52 may include a suction section that applies a suction force to the discharge port 51d. According to an instruction from the controller 54, the discharge accelerator 52 including the suction section sets the vicinity of the discharge port 51d to a negative pressure and applies the suction force to the discharge port 51d. Accordingly, the biological sample extracted into the extractant is discharged from the discharge port 51d according to the applied suction force.

The discharge accelerator 52 may include an exciter that vibrates the extraction container 51. The discharge accelerator 52 including the exciter vibrates the extraction container 51 according to an instruction from the controller 54. Accordingly, the pressure inside the extraction container 51 changes and the biological sample extracted into the extractant is discharged from the discharge port 51d.

The sensor 53 is a sensor that detects that the extraction container 51 is set in a predetermined position. When detecting that the extraction container 51 is set in the predetermined position, the sensor 53 transmits detection information to the controller 54. The sensor 53 is, for example, a weight sensor disposed in a predetermined position and transmits the detection information to the controller 54 by detecting the weight of the extraction container 51. Alternatively, the sensor 53 may be an infrared sensor or the like disposed near the predetermined position. The sensor 53 may be a sensor that detects that the insertion port 51i is covered by the lid 514 and the extraction container 51 is sealed.

The controller 54 includes one or a plurality of CPUs (central processing units) and executes various kinds of processing according to a program. The controller 54 instructs the discharge accelerator 52 to discharge the biological sample from the discharge port 51d based on the detection information sent from the sensor 53. According to an instruction from the controller 54, for example, the discharge accelerator 52 pressurizes the inside of the extraction container 51 and discharges the biological sample extracted into the extractant from the discharge port 51d of the extraction container 51.

<Operation of the Extraction Device 50>

Such an extraction device 50 operates, for example, as follows.

First, when the collection tool C to which the biological sample adheres and the extraction container 51 containing the extractant are set in a predetermined position by the tester or the like, the sensor 53 detects the extraction container 51 and sends a detection signal to the controller 54. At this time, after inserting the collection tool C to which the biological sample adheres and the extractant from the insertion port 51i of the extraction container 51, the tester or the like covers the insertion port 51i with the lid 514 to seal the extraction container 51 and sets the extraction container 51 at the predetermined position. The tester or the like may insert the collection tool C to which the biological sample adheres into the extraction container 51 containing the extractant in advance or may insert the collection tool C to which the biological sample adheres into the extraction container 51 and thereafter add the extractant into the extraction container 51. In the extraction container 51, when the collection tool C is inserted to the vicinity of the nozzle portion 511, the biological sample attached to the collection tool C is rubbed off by the extraction supporting structure 516, and the extraction and dispersion of the biological sample in the extractant are accelerated.

When receiving the detection signal from the sensor 53, the controller 54 instructs the discharge accelerator 52 to discharge the biological sample from the discharge port 51d of the extraction container 51. According to an instruction from the controller 54, the discharge accelerator 52 causes air or the like to flow into the extraction container 51 via the connection hole 51c of the lid 514. Accordingly, the pressure inside the extraction container 51 increases and the biological sample extracted into the extractant is discharged to a predetermined place from the discharge port 51d of the extraction container 51. The biological sample discharged from the discharge port 51d is, for example, mixed with a reagent in the predetermined place.

<Action Effects of the Extraction Device 50>

Since the controller 54 is provided in the extraction device 50 of the present embodiment, the biological sample extracted into the extractant in the extraction container 51 is discharged from the discharge port 51d according to an instruction from the controller 54. Therefore, the tester or the like can provide the biological sample extracted into the extractant in the predetermined place with less operation. Action effects of the test system 1 are explained below.

When a controller is not provided in a biological sample extraction device, for example, a tester takes out a specified amount of a biological sample extracted into an extractant in an extraction container from the extraction container with a pipette or the like and provides the biological sample int a predetermined place. That is, complicated operation for extracting the specified amount of the biological sample extracted into the extractant from the extraction container is required.

When a tester unaccustomed to handling of the biological sample, for example, a subject himself/herself performs such complicated operation, it is likely that the operation cannot be performed according to a prescribed procedure. If the operation according to the prescribed procedure is not performed, it is likely that problems such as deterioration in test accuracy and secondary infection occur.

In contrast, in the extraction device 50, since the controller 54 is provided, the controller 54 instructs the discharge accelerator 52, whereby the biological sample extracted as the extractant in the extraction container 51 is automatically discharged from the discharge port 51d. For example, a discharge amount can be adjusted by controlling a flow rate of air or the like sent into the extraction container 51 by the discharge accelerator 52. Specified amounts of the biological sample and the extractant are discharged. Therefore, the tester can discharge the specified amount of the biological sample to a predetermined place without operating a pipette or the like. That is, the biological sample extracted into the extractant can be provided in the predetermined place with less operation.

As explained above, in the extraction device 50, the specified amount of the biological sample can be easily provided in the predetermined place regardless of the level of the skill of the tester. Therefore, the test can be performed with high accuracy and safely. The extraction device 50 in which the tester performs less operation as explained above can also be suitably used when a large number of biological samples are tested in a short time. Further, in the extraction device 50, the subject himself/herself can collect and test a biological sample and immediately obtain a test result.

The sensor 53 is provided in the extraction device 50. An instruction is sent from the controller 54 to the discharge accelerator 52 based on a detection signal of the sensor 53. That is, an instruction is sent from the controller 54 to the discharge accelerator 52 without the tester performing operation. The biological sample extracted into the extractant is discharged from the discharge port 51d of the extraction container 51. Therefore, the operation can be further simplified.

Further, in the extraction device 50, since the extraction container 51 includes the discharge port 51d separately from the insertion port 51i into which the collection tool C and the like are inserted, it is possible to discharge the biological sample extracted into the extractant without removing the lid 514 after the biological sample is extracted or dispersed into the extractant. Accordingly, the operation can be further simplified.

In addition, in the extraction device 50, since the extraction supporting structure 516 is provided in the extraction container 51, the extraction or dispersion of the biological sample is accelerated by rubbing the collection tool C or the like to which the biological sample adheres against the extraction supporting structure 516. Accordingly, the operation can be further simplified.

As explained above, in the extraction device 50 in the present embodiment, since the controller 54 is provided, the biological sample extracted into the extractant in the extraction container 51 is discharged from the discharge port 51d according to an instruction from the controller 54. Therefore, the tester or the like can provide the biological sample extracted into the extractant in the predetermined place with less operation. Accordingly, a test process can be simplified.

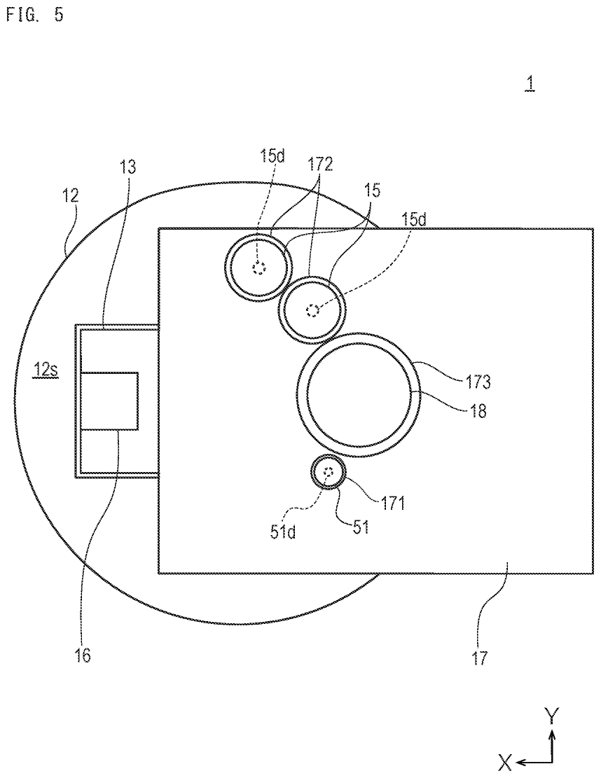

A test system (the test system 1 illustrated in FIGS. 4 and 5 explained below) to which the extraction device 50 is applied is explained below.

### Application Example

<Configuration of the Test System 1>

FIGS. 4 and 5 illustrate a schematic configuration of the test system 1 to which the extraction device 50 is applied. FIG. 4 illustrates a configuration of a side surface (an XZ plane) of the test system 1. FIG. 5 illustrates a configuration of an upper surface (an XY plane) of the test system 1. In the following explanation, it is assumed that the vertical direction of the test system 1 is the Z direction.

The test system 1 is a device that performs optical measurement of a mixture of a biological sample and a reagent. In addition to the extraction device 50, the test system 1 includes a shaft portion 11, a support table 12, a detector 13, a reagent supplier 15, an optical measurer 16, a holding table 17, an extractant supplier 18, and a waste liquid storage 19.

In the test system 1, the support table 12 and the detector 13 are provided in this order on the shaft portion 11. The holding table 17 is disposed above the support table 12. The reagent supplier 15, the optical measurer 16, the extractant supplier 18, and the extraction container 51 are held on the holding table 17. The waste liquid storage 19 is disposed below the support table 12.

The shaft portion 11 includes a rotating shaft 11a, a coupling section 11b, and a rotating shaft 11c in order from the bottom. For example, the rotating shaft 11a is connected to a motor (not illustrated) and axially rotates. The coupling section 11b couples the rotating shaft 11c coaxially with the rotating shaft 11a. The rotating shaft 11c axially rotates according to the rotation of the rotating shaft 11a.

The support table 12 provided on the rotating shaft 11c has a rotation surface 12s (an XY plane) substantially perpendicular to the rotating shafts 11a and 11c. The rotation surface 12s has, for example, a circular planar shape (FIG. 2). The support table 12 is a so-called turntable. The rotation surface 12s rotates clockwise or counterclockwise in the XY plane according to the rotation of the rotating shafts 11a and 11c. The detector 13 is provided on the rotation surface 12s. The detector 13 is displaced according to the rotation of the rotation surface 12s. For example, one detector 13 is provided on the rotation surface 12s. A plurality of detectors 13 may be provided on the rotation surface 12s.

The reagent is supplied from the reagent supplier 15 to the detector 13 supported by the support table 12. The biological sample is supplied from the extraction container 51. The detector 13 to which the reagent and the biological sample are supplied is irradiated with light from the optical measurer 16.

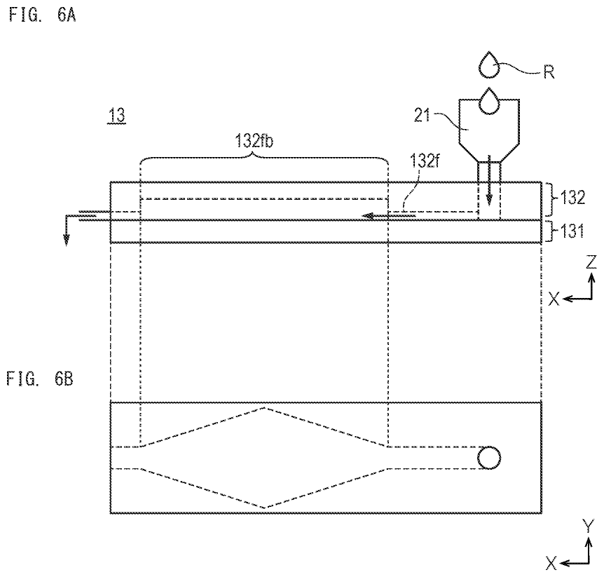

FIGS. 6A and 6B illustrate an example of a configuration of the detector 13. FIG. 6A illustrates a configuration of a side surface (an XZ plane) of the detector 13. FIG. 6B illustrates a configuration of an upper surface (an XY plane) of the detector 13. For example, the detector 13 has a stacked structure of an opaque member 131 and a transparent member 132 in order from the side of the rotation surface 12s. For example, a receiver 21 is provided on the detector 13.

The opaque member 131 is, for example, a plate-like member having a rectangular planar shape. The opaque member 131 is configured by a material having low transmittance with respect to light emitted from the optical measurer 16. The opaque member 131 includes, for example, a single crystal silicon (Si) material, a resin material, or the like.

The transparent member 132 is stacked on the opaque member 131, and has, for example, substantially the same planar shape as the opaque member 131. A channel 132f through which liquid containing the reagent and the biological sample flows is provided in the transparent member 132. With the channel 132f, the liquid containing the reagent and the biological sample flows, for example, along a long side direction (the X direction in FIG. 3) of the transparent member 132. The channel 132f includes a widened section 132fb having width larger than the width of the channel 132f in other portions. The widened section 132fb is provided, for example, in the center of the channel 132f. For example, the biological sample and the reagent stored in the widened section 132fb are irradiated with light from the optical measurer 16 and optical characteristics are measured. In the channel 132f, a surface on the optical measurer 16 side may be opened.

The transparent member 132 is configured by a material having high transmittance with respect to the light irradiated from the optical measurer 16. The light irradiated from the optical measurer 16 reaches the widened section 132fb. The transparent member 132 includes, for example, a glass material, a resin material or the like. The glass material included in the transparent member 132 is, for example, silica glass or the like. High light transmittance can be realized by configuring the transparent member 132 using such a glass material. The resin material included in the transparent member 132 is, for example, dimethylpolysiloxane, polystyrene, polycarbonate, cycloolefin, acrylic, or the like. Dimethylpolysiloxane has high transferability to a mold. The transparent member 132 can be easily formed. By using polystyrene, polycarbonate, cycloolefin, and acrylic, the transparent member 132 can be mass-produced by injection molding. Noise in optical measurement can be reduced by forming the transparent member 132 using polystyrene and cycloolefin having less autofluorescence. By forming the transparent member 132 using polycarbonate having a high refractive index, the test system 1 can be reduced in size. By forming the transparent member 132 using acrylic having high light transmissivity, attenuation of light at the time of light guide can be suppressed and accuracy of optical measurement can be improved. A light incident surface of the transparent member 132 is preferably optically smooth. Accordingly, the accuracy of measurement by the optical measurer 16 can be improved. The thickness of the transparent member 132 is not particularly limited and can be adjusted in consideration of rigidity, light transmittance, and the like.

The receiver 21 on the transparent member 132 plays a role of receiving the biological sample supplied from the extraction container 51 and the reagent supplied from the reagent supplier 15 in an upper portion of the detector 13 and feeding the biological sample and the reagent to the channel 132f of the detector 13 (more specifically, the transparent member 132). The receiver 21 has, for example, a funnel shape. One opening of the receiver 21 is widened further away from the transparent member 132. The other opening of the receiver 21 communicates with the channel 132f For example, the biological sample and the reagent are mixed in the receiver 21 and thereafter fed into the channel 132f. For example, the receiver 21 is vibrated by bringing an exciting mechanism into contact with the outside of the receiver 21. The biological sample and the reagent are mixed in the receiver 21. Alternatively, the biological sample and the reagent may be mixed in the channel 132f For example, by sucking the inside of the channel 132f from one end and pumping the channel 132f, gas and liquid in the channel 132f move and the biological sample and the reagent are mixed in the channel 132f.

The extraction device 50 has a role of extracting, with an extractant, a biological sample from a collection tool to which the biological sample adheres and supplying the biological sample extracted into the extractant to the detector 13. For example, the extraction container 51 of the extraction device 50 is held on the holding table 17. The extraction container 51 is preferably set such that the discharge port 51d is provided in the gravity direction of the insertion port 51i. Accordingly, the extractant and the biological sample are easily discharged from the discharge port 51d.

The extractant supplier 18 is held on the holding table 17 together with, for example, the extraction container 51. The extractant supplier 18 stores a predetermined amount of the extractant. The extractant stored in the extractant supplier 18 is supplied into the extraction container 51. The extractant may be supplied from the extractant supplier 18 into the extraction container 51 via a tube or the like or may be supplied by a pipette or the like.

The reagent supplier 15 is held on the holding table 17 together with the extraction container 51 and the extractant supplier 18. The reagent supplier 15 stores a predetermined amount of the reagent. The reagent stored in the reagent supplier 15 is supplied to the detector 13. In the reagent supplier 15, for example, a reagent dispersed or dissolved in a solvent is stored. The reagent supplier 15 has, for example, a substantially columnar shape. The discharge port 15d is provided at the lower end the reagent supplier 15. The discharge port 15d is disposed, for example, in a position opposed to the rotation surface 12s. The reagent stored in the reagent supplier 15 is supplied to the detector 13 via the discharge port 15d. In FIG. 5, an example is illustrated in which the test system 1 includes the two reagent suppliers 15. However, the test system 1 may include one reagent supplier 15 or may include three or more reagent suppliers 15.

The reagent stored in the reagent supplier 15 is, for example, a dye, a fluorescent substance, nanoparticles, or the like and generates physical or chemical bond with a substance to be detected contained in the biological sample. As the reagent, a publicly-known reagent can be used. The fluorescent substance is, for example, a fluorescent dye, a quantum dot or the like. The nanoparticles are polystyrene beads, gold nanoparticles, or the like. For example, by bonding such a reagent with the substance to be detected, an optical signal generated at the time of light irradiation increases and the substance to be detected is easily detected. In particular, such a reagent is effective when the optical signal of the substance to be detected alone is feeble. The reagent may be a substance that causes light absorption or light scattering. At this time, by bonding the reagent with the substance to be detected, the light intensity generated at the time of light irradiation decreases and the optical signal is amplified.

The bonding between the reagent and the substance to be detected is, for example, bonding by physical adsorption, bonding by antigen-antibody reaction, bonding by DNA hybridization, biotin-avidin bonding, chelate bonding, amino bonding, or the like. The bonding by physical adsorption is, for example, a hydrogen bonding that makes use of an electrostatic bonding force, or the like. In the bonding by physical adsorption, pretreatment or the like of the biological sample is unnecessary. A conjugate of the reagent and the substance to be detected can be easily generated. The bonding by the antigen-antibody reaction is, for example, specific bonding between a substance to be detected such as a virus and the reagent. Occurrence of noise derived from impurities other than the substance to be detected contained in the biological sample can be suppressed. When the substance to be detected is detected using the antigen-antibody reaction, for example, a reagent to which an antibody is bonded is prepared in advance.

The extraction container 51 and the reagent supplier 15 are disposed along a direction in which the detector 13 is displaced, that is, a rotation direction of the rotation surface 12s. For example, the extraction container 51, the reagent supplier 15, and the optical measurer 16 are disposed counterclockwise in this order (FIG. 5). The extraction container 51, the reagent supplier 15, and the optical measurer 16 may be disposed clockwise in this order. The extraction container 51, the reagent supplier 15, and the optical measurer 16 may be disposed counterclockwise or clockwise in the order of the reagent supplier 15, the extraction container 51, and the optical measurer 16.

The optical measurer 16 is held on the holding table 17 together with, for example, the extraction container 51 and the reagent supplier 15 and measures optical characteristics of the biological sample and the reagent supplied to the detector 13. The optical measurer 16 is disposed above the rotation surface 12s. The detector 13 can be disposed in a position opposed to the optical measurer 16, that is, right below the optical measurer 16. From a measurement result of the optical measurer 16, the presence or a content of the substance to be detected contained in the biological sample is detected.

For example, the optical measurer 16 irradiates the detector 13 with light and detects an optical signal generated by the detector 13. The optical measurer 16 includes, for example, an irradiator and a light receiver. The irradiator and the light receiver are disposed in, for example, positions opposed to the rotation surface 12s.

The irradiator includes a light source and irradiates light from the light source toward the detector 13. The light irradiated from the irradiator to the detector 13 is, for example, light in a wavelength region capable of exciting a fluorescent substance. The light source is, for example, a lamp, an LED (light emitting diode), a laser, or the like. The light generated by the light source may be monochromatic light or light having a wide wavelength band. When the light generated by the light source has the wide wavelength band, the irradiator preferably includes an optical filter such as a bandpass filter. When a lamp, an LED, or the like is used as the light source, the irradiator preferably includes a guide member that restricts a traveling direction of light generated by the light source. The guide member is, for example, a collimate lens or the like.

The light receiver includes, for example, an imaging device such as a photodiode, a photodetector, a CCD (charge coupled device) image sensor, and a CMOS (complementary metal oxide semiconductor) image sensor. The photodetector is, for example, a photomultiplier tube or the like. A publicly-known imaging device can be used as the light receiver. Light intensity or a spectrum of light made incident on the optical measurer 16 is detected by the light receiver. The light receiver may detect the intensity of light having a single wavelength or may detect the intensity of light having a plurality of wavelengths. When the light irradiated from the irradiator is made incident on the detector 13, for example, the conjugate of the reagent and the substance to be detected is excited by this light and an optical signal is generated. The generated optical signal is directly made incident or reflected in an interface between the transparent member 132 and the opaque member 131 and made incident on the light receiver.

The holding table 17 that holds the extraction container 51, the reagent supplier 15, and the optical measurer 16 is disposed above the support table 12. A part of the holding table 17 faces the support table 12. On the upper surface of the holding table 17, a sample holder 171, a reagent holder 172, and an extractant holder 173 are provided.

The sample holder 171, the reagent holder 172, and the extractant holder 173 are fixed to the upper surface of the holding table 17. Each of the sample holder 171, the reagent holder 172, and the extractant holder 173 has, for example, a ring shape. The extraction container 51 is held on the inner side of the sample holder 171. The reagent supplier 15 is held on the inner side of the reagent holder 172, and the extractant supplier 18 is held on the inner side of the extractant holder 173. The extraction container 51, the reagent supplier 15, and the extractant supplier 18 are configured to be detachably attachable to the sample holder 171, the reagent holder 172, and the extractant holder 173, respectively. The sensor 53 of the extraction device 50 transmits a detection signal to the controller 54, for example, by detecting that the extraction container 51 is held by the sample holder 171.

In the waste liquid storage 19 disposed below the support table 12, for example, waste liquid caused when the detector 13 is cleaned is stored. For example, after the optical characteristics of the mixture of the biological sample and the reagent supplied to the detector 13 are measured, a cleaning solution is supplied to the detector 13. The cleaning solution is supplied to the detector 13, for example, via the receiver 21. Together with the cleaning solution supplied to the detector 13, the biological sample and the reagent in the channel 132f are discharged to the waste liquid storage 19. The waste liquid is discharged to the waste liquid storage 19, for example, by sucking one end of the channel 132f In this way, by cleaning the detector 13 after measuring the optical characteristics, the detector 13 can be reused. A cleaning solution supplier (not illustrated) storing the cleaning solution may be disposed below the support table 12.

<Detection Method in which the Detection Device is Used>

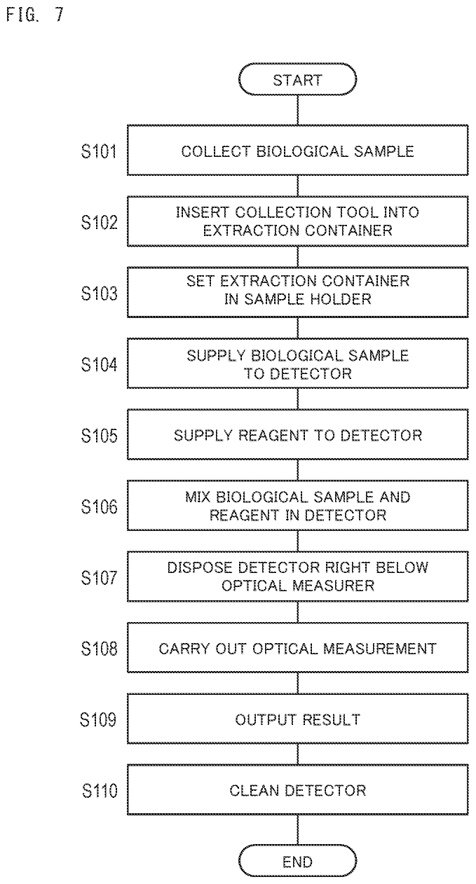

A test method in which the test system 1 of the present embodiment is explained below with reference to FIG. 7. FIG. 7 is a flowchart illustrating an example of a test method in which the test system 1 is used.

First, a biological sample is collected from a subject using the collection tool C or the like (step S101). Specifically, a tester wipes saliva or a nasal swab from the pharynx, the nasal cavity, or the like of the subject using the collection tool C.

Subsequently, the tester inserts the collection tool C to which the biological sample of the subject adheres into the extraction container 51 from the insertion port 51i and seals the extraction container 51 with the lid 514 (step S102). For example, an extractant is put in the extraction container 51 before the collection tool C is inserted.

Subsequently, the tester sets the extraction container 51 in the sample holder 171 such that the discharge port 51d of the extraction container 51 is disposed right above the detector 13 placed on the rotation surface 12s (step S103). For example, when the sensor 53 detects the setting on the sample holder 171, a detection signal is sent from the sensor 53 to the controller 54. The controller 54 instructs the discharge accelerator 52 to discharge the biological sample holder from the discharge port 51d. According to this instruction, the discharge accelerator 52 discharges, from the discharge port 51d, a specified amount of the biological sample extracted into the extractant in the extraction container 51. That is, the biological sample is supplied from the discharge port 51d of the extraction container 51 to the detector 13 (step S104).

Subsequently, the detector 13 is disposed right below a reagent supply port 15M by rotating the rotation surface 12s and thereafter a prescribed amount of the reagent is supplied from the reagent supplier 15 to the detector 13 via the reagent supply port 15M (step S105).

Next, the tester mixes the biological sample and the reagent supplied to the detector 13 (step S106). For example, the tester mixes the biological sample and the reagent by performing reciprocating liquid feeding in the channel 132f. Accordingly, a conjugate of the reagent and the substance to be detected contained in the biological sample is generated.

Subsequently, the tester rotates the rotation surface 12s to thereby dispose the detector 13 right below the optical measurer 16 (step S107) and performs optical measurement of the mixed biological sample and reagent (step S108). In the optical measurement, the optical measurer 16 irradiates light toward the detector 13 and receives light made incident on the optical measurer 16 from the detector 13 side.

After performing the optical measurement of the detector 13, the tester outputs a result of the optical measurement (step S109). The result of the optical measurement is, for example, discriminated by image processing and output.

Thereafter, the tester cleans the detector 13 (step S110). The cleaning of the detector 13 is performed, for example, as follows. First, the rotation surface 12s is rotated to displace the detector 13 to right above the cleaning solution supplier. The cleaning solution is supplied from the cleaning solution supplier to the detector 13. Subsequently, the biological sample and the reagent in the channel 132f are discharged to the waste liquid storage 19 together with the supplied cleaning solution. The discharge to the waste liquid storage 19 may be performed after the detector 13 is displaced to right above the waste liquid storage 19. Subsequently, the rotation surface 12s is rotated to displace the detector 13 to right below the optical measurer 16 and carry out the optical measurement of the detector 13. Thereafter, the result of the optical measurement is output. When it is confirmed that the detector 13 is successfully cleaned, the cleaning is ended. When the cleaning of the detector 13 is insufficient, the supply of the cleaning solution to the detector 13 and the discharge of the cleaning solution are repeated.

After the cleaning of the detector 13 is performed, the detection is ended. Alternatively, after the cleaning of the detector 13 is performed, the test method may return to the process in step S101.

Since the extraction device 50 is used in the test system 1, the tester can supply the biological sample extracted into the extractant to the detector 13 with less operation. Accordingly, the test process can be simplified.

Further, in the test system 1, the discharge port 51d and the reagent supply port 15M can be disposed above the rotation surface 12s. Therefore, by placing the detector 13 on the rotation surface 12s and rotating the rotation surface 12s, the detector 13 is displaced to right below each of the discharge port 51d and the reagent supply port 15M. Therefore, the biological sample and the reagent can be supplied to the detector 13 from each of the discharge port 51d and the reagent supply port 15M by simple operation.

As explained above, the extraction device and the test system of the present invention are explained in the embodiment. However, it goes without saying that those skilled in the art can appropriately add, modify, and omit the present invention within the scope of the technical idea of the present invention.

For example, in the embodiment explained above, an example is explained in which the controller 54 instructs the discharge accelerator 52 based on the detection signal from the sensor 53. However, the controller 54 may instruct the discharge accelerator 52 based on another signal. For example, the controller 54 may instruct the discharge accelerator 52 based on button operation or the like of the tester or the like.

According to an instruction from the controller 54, the discharge accelerator 52 may immediately discharge the biological sample from the discharge port 51d of the extraction container 51 or may discharge the biological sample after a predetermined time elapses.

For example, in the embodiment explained above, an example is explained in which the detector 13 after the optical measurement is performed is cleaned and the detector 13 is reused. However, the detector 13 may be replaced with a new detector 13 every time the optical measurement is performed. At this time, a waste liquid storage may not be provided in the detection device.

In the embodiment explained above, an example is explained in which both of the irradiator and the light receiver of the optical measurer 16 are provided above the rotation surface 12s. However, the irradiator and the light receiver of the optical measurer 16 may be provided in a position other than the position above the rotation surface 12s. For example, the irradiator may be provided above the rotation surface 12s and the light receiver may be provided below the rotation surface 12s.

In the embodiment explained above, an example is explained in which the biological sample is the saliva or the nasal swab. However, the biological sample may be a biological sample containing a substance to be detected and may be, for example, blood, urine, or the like. The extraction device 50 may extract objects other than the biological sample and may extract, for example, chemicals, environmental water, clean water, sewage, and the like.

The test method of the test system 1 explained above may include steps other than the steps of the flowchart explained above or may not include a part of the steps explained above. The order of the steps is not limited to the embodiment explained above.

Although embodiments of the present invention have been described and illustrated in detail, the disclosed embodiments are made for purpose of illustration and example only and not limitation. The scope of the present invention should be interpreted by terms of the appended claims.

1. An extraction device comprising:
an extraction container including a discharge port and capable of storing a biological sample adhering to a collection tool and an extractant into which said biological sample is extracted;
a discharge accelerator configured to discharge said biological sample extracted into said extractant in said extraction container from said discharge port; and
a controller configured to instruct said discharge accelerator to discharge said biological sample from said discharge port.

2. The extraction device according to claim 1, wherein, when said extraction container is set in a predetermined position, said controller instructs the discharge from said discharge port.

3. The extraction device according to claim 2, further comprising a sensor configured to detect the setting of said extraction container in the predetermined position, wherein
said controller instructs the discharge from said discharge port based on the detection of the setting of said extraction container by said detector.

4. The extraction device according to claim 1, wherein said discharge accelerator increases pressure inside said extraction container to thereby discharge, from said discharge port, said biological sample extracted into said extractant in said extraction container.

5. The extraction device according to claim 1, wherein said discharge accelerator applies a suction force to said discharge port to thereby discharge, from said discharge port, said biological sample extracted into said extractant in said extraction container.

6. The extraction device according to claim 1, wherein, with vibration of said extraction container, said discharge accelerator discharges, from said discharge port, said biological sample extracted into said extractant in said extraction container.

7. The extraction device according to claim 1, wherein said extraction container includes said discharge port and an insertion port that is provided at a position different from said discharge port and into which at least one of said collection tool to which said biological sample adheres and said extractant can be inserted.

8. The extraction device according to claim 7, further comprising a lid that covers said insertion port of said extraction container.

9. The extraction device according to claim 8, wherein a connection hole connected to said discharge accelerator is provided in said lid.

10. The extraction device according to claim 7, wherein said extraction container includes:
a nozzle portion in which said discharge port is provided;
a columnar portion coupled to said nozzle portion and having a first radius; and
an insertion portion having a second radius larger than said first radius, said insertion port being provided in said insertion portion.

11. The extraction device according to claim 10, wherein a filter through which said biological sample and said extractant flowing toward said discharge port pass is provided in said nozzle portion.

12. The extraction device according to claim 1, wherein an extraction supporting structure for extracting or dispersing said biological sample into said extractant is provided in said extraction container.

13. The extraction device according to claim 12, wherein said extraction supporting structure is configured by a protrusion provided in said extraction container.

14. The extraction device according to claim 13, wherein said protrusion extends in a predetermined direction.

15. The extraction device according to claim 13, wherein said protrusion has a curved shape.

16. The extraction device according to claim 12, wherein said collection tool to which said biological sample adheres is rubbed against said extraction supporting structure to extract or disperse said biological sample into said extractant.

17. The extraction device according to claim 1, wherein said extraction container is configured to be disposable.

18. A test system comprising:
the extraction device according to claim 1;
a detector configured to receive a biological sample and an extractant discharged from said discharge port of said extraction container;
a reagent supplier configured to supply a reagent to said detector; and
an optical measurer configured to measure optical characteristics of said biological sample and said reagent supplied to said detector.
